(19) United States
(12) Patent Application Publication
(10) Pub. No.: US 2025/0168035 A1
(43) Pub. Date: May 22, 2025

(54) METHOD AND DEVICE FOR PROCESSING DATA ASSOCIATED WITH AT LEAST ONE INTERFACE DEVICE

(71) Applicant: Robert Bosch GmbH, Stuttgart (DE)

(72) Inventor: Felix Fellhauer, Stuttgart (DE)

(21) Appl. No.: 18/840,955

(22) PCT Filed: Feb. 1, 2023
(86) PCT No.: PCT/EP2023/052404

§ 371 Date: Aug. 23, 2024

(30) Foreign Application Priority Data
Apr. 14, 2022 (DE) 10 2022 203 799.5

(51) Int. Cl. H04L 12/40; G06F 1/3209; H04L 12/12

(52) U.S. Cl. CPC H04L 12/40039; G06F 1/3209; H04L 12/12; H04L 2012/40215; H04L 2012/40273

(57) ABSTRACT

A method for processing data associated with at least one interface device. The method includes: ascertaining first information which indicates whether at least one component of a second interface device designed to at least temporarily exchange data with a first interface device is to be set to an energy-saving mode, and, if the information indicates that the at least one component of the second interface device is to be set to the energy-saving mode, sending a first command to the second interface device, the command signaling to the second interface device that the at least one component of the second interface device is to be set to the energy-saving mode.

### FIELD

The present invention relates to a method, for example a computer-implemented method, for processing data associated with at least one interface device.

The present invention furthermore relates to a device for processing data associated with at least one interface device.

### SUMMARY

Exemplary embodiments of the present invention relate to a method, for example a computer-implemented method, for processing data associated with at least one interface device, comprising: ascertaining first information which indicates whether at least one component of a second interface device designed to at least temporarily exchange data with a first interface device is to be set to an energy-saving mode, and, if the information indicates that the at least one component of the second interface device is to be set to the energy-saving mode, sending a first command to the second interface device, said command signaling to the second interface device that the at least one component of the second interface device is to be set to the energy-saving mode. In further exemplary embodiments, an operation of the at least one component of the second interface device, for example with regard to an energy-saving mode, can thereby be flexibly controlled, for example by the first interface device or a target system for the first interface device.

In further exemplary embodiments of the present invention, it is provided that, for example on the basis of the first information and/or the first command, at least one component of the first interface device is, e.g., also, set to an energy-saving mode.

In further exemplary embodiments of the present invention, it is provided that, if the first information indicates that the at least one component of the second interface device is not, e.g., not at the moment, to be set to the energy-saving mode, sending the first command to the second interface device is not carried out, i.e., is omitted.

In further exemplary embodiments of the present invention, the energy-saving mode is characterized in that an electrical power consumption and/or energy consumption in the energy-saving mode is lower than outside the energy-saving mode, for example in a regular operating mode.

In further exemplary embodiments of the present invention, it may be provided that, even if its at least one component is in the energy-saving mode, the second interface device can exchange data, e.g., with the first interface device, e.g., in the sense of the data exchange already described above by way of example. For example, a, e.g., maximum, data rate can be reduced in the energy-saving mode in comparison to the regular operating mode, which can result in savings in terms of electrical power consumption and/or energy consumption, for example. For example, the, for example maximum, data rate achievable in the energy-saving mode may be sufficient to exchange signals or information that can be used for synchronizing the second interface device with the first interface device.

In further exemplary embodiments of the present invention, the energy-saving mode can be characterized, for example, in that the data rate in the energy-saving mode corresponds to the data rate of the regular operating mode, wherein it is however defined, for example, that, during the energy-saving mode, data transmissions (e.g., at the regular data rate) only take place in a specifiable first fraction (e.g., 10 percent) of a, e.g., specifiable, time interval (“duty cycle”), while, for example, in a further fraction of the specifiable time interval, for example in the remaining time period of the specifiable time interval, (e.g., 90%) no data transmissions take place. This can also result in savings with regard to electrical power consumption and/or energy consumption, e.g., averaged over the specifiable time interval, in further exemplary embodiments.

In further exemplary embodiments of the present invention, the at least one component of the second interface device, which can, for example, be set to the energy-saving mode at least temporarily, can, for example, be an interface module, for example a PHY module, or a component of a PHY module, e.g., a sending device (“transmitter”) of the PHY module. For example, the at least one component of the second interface device can be activated for the aforementioned first fraction (e.g., 10% of the specifiable time interval) and deactivated for the aforementioned second fraction (e.g., 90% of the specifiable time interval) during the energy-saving mode.

In further exemplary embodiments of the present invention, it is provided that the first command of the second interface device signals that the at least one component of the second interface device is to be set to the energy-saving mode for a specifiable time period.

In further exemplary embodiments of the present invention, it is provided that the first interface device and the second interface device are each designed as an Ethernet interface device, for example an automotive Ethernet interface device, for example according to or on the basis of at least one of the following standards: a) IEEE 802.bp, b) IEEE 802.3ch, c) IEEE 802.3cy, d) IEEE 802.3cg.

In further exemplary embodiments of the present invention, the principle according to the embodiments is also applicable to other standards, for example Ethernet standards other than the ones mentioned above.

In further exemplary embodiments of the present invention, it is provided that a component of the first and/or second interface device that can, for example, be set to the energy-saving mode on the basis of the first command is, for example, an interface module, for example a PHY module, or a component of a PHY module, e.g., a sending device and/or a receiving device.

In further exemplary embodiments of the present invention, it is provided that ascertaining the first information comprises at least one of the following elements: a) forming the first information, for example in the first interface device or in a target system (e.g., control unit) comprising the first interface device, b) forming the first information on the basis of at least one operating variable (e.g., temperature) of the second interface device or of a target system comprising the second interface device, wherein, for example, the operating variable of the second interface device can be received by the first interface device via a communication medium that can be used for the data exchange, c) receiving the first information by means of the second interface device (e.g., local formation of the first information in the second interface device is also possible in further exemplary embodiments) and/or by means of at least one further unit.

In further exemplary embodiments of the present invention, it is provided that the method comprises at least one of the following elements: a) receiving second information from at least one further unit (e.g., from a control unit or another control unit), b) forming the first information on the basis of the second information, c) sending the first information on the basis of the second information.

In further exemplary embodiments of the present invention, it is provided that sending comprises: sending a sleep signal symbol to the second interface device and, optionally, deactivating at least one component of the first interface device for a, or the, specifiable time period. As a result, the second interface device can, for example, set its receiving device to the energy-saving mode, and the first interface device can, for example, set its sender, which is, for example, connected to the sending device of the second interface device via a wired transmission medium, to the energy-saving mode.

In further exemplary embodiments of the present invention, the specifiable time period is a time period for which the at least one component of the first interface device is set to the energy-saving mode, for example a low-power idle (LPI) mode.

In further exemplary embodiments of the present invention, a duty factor or duty cycle for the energy-saving mode can be defined, for example as a ratio of an active time (i.e., operation without energy-saving mode) and the specifiable time period of deactivation. In further exemplary embodiments, the duty factor can, for example, be specified, for example by repeatedly setting the at least one component, e.g., of the first interface device, to the energy-saving mode, e.g., sleep mode (or LPI mode). As a result, in further exemplary embodiments, information-based switching can, for example, be realized, e.g., in contrast to conventional switching between “quiet” and “refresh” modes within the LPI mode.

In general, in further exemplary embodiments of the present invention, at least one local component of a component (e.g., first interface device) performing the method according to the embodiments can also be set to an energy-saving mode at least temporarily, for example if the method provides for setting at least one component of the second interface device to an energy-saving mode.

In further exemplary embodiments of the present invention, it is provided that the method comprises: controlling and/or regulating an electrical power consumption of the second interface device and/or a temperature of the second interface device or of a target system comprising the second interface device, for example by means of the first information or by sending the first command.

In further exemplary embodiments of the present invention, it is provided that the method comprises: specifying a duty cycle for the energy-saving mode of the at least one component.

Further exemplary embodiments of the present invention relate to a device for performing the method according to the example embodiments of the present invention.

Further exemplary embodiments of the present invention relate to an interface module, for example PHY module, for an interface device, comprising at least one device according to the example embodiments of the present invention.

Further exemplary embodiments of the present invention relate to a network coupling element, for example a switch, for example an automotive switch, comprising at least one device according to the example embodiments of the present invention and/or at least one interface module according to the example embodiments of the present invention.

Further exemplary embodiments of the present invention relate to a module, for example a sensor module and/or control unit, comprising at least one device according to the embodiments and/or at least one interface module according to the embodiments and/or at least one network coupling element according to the embodiments.

Further exemplary embodiments of the present invention relate to a communication system, for example for a vehicle, comprising at least one device according to the embodiments and/or at least one interface module according to the embodiments and/or at least one network coupling element according to the embodiments and/or at least one module according to the embodiments.

Further exemplary embodiments of the present invention relate to a computer-readable storage medium comprising commands that, when executed by a computer, cause said computer to perform the method according to the example embodiments of the present invention.

Further preferred example embodiments of the present invention relate to a computer program comprising commands that, when the program is executed by a computer, cause said computer to perform the method according to the embodiments.

Further exemplary embodiments of the present invention relate to a data carrier signal that transmits and/or characterizes the computer program according to the example embodiments of the present invention.

Further exemplary embodiments of the present invention relate to a use of the method according to the example embodiments and/or of the device according to the example embodiments and/or of the interface module according to the example embodiments and/or of the network coupling element according to the example embodiments and/or of the module according to the example embodiments and/or of the communication system according to the example embodiments and/or of the computer-readable storage medium according to the example embodiments and/or of the computer program according to the example embodiments and/or of the data carrier signal according to the example embodiments for at least one of the following elements: a) signaling that the at least one component of the second interface device is to be set to the energy-saving mode, b) using low-power functions, for example an energy-saving mode, of the at least one component of the second interface device, c) controlling and/or regulating low-power functions, for example an energy-saving mode, of the at least one component of the second interface device, d) regulating the temperature of a module, for example a sensor module, for example a camera module, comprising the second interface device, e) regulating the power of a module, for example a sensor module, for example a camera module, comprising the second interface device, f) regulating an electrical energy consumption of a module comprising the second interface device, g) integrating modules, for example sensor modules, for example sensor modules designed to output data at a comparatively high data rate, for example of greater than 1000 Mbit/s, into a communication system, for example an automotive Ethernet communication system, h) operating sensor modules, for example of the RADAR type and/or LIDAR type and/or camera type.

Further features, possible applications and advantages of the present invention will be apparent from the following description of exemplary embodiments of the present invention shown in the figures. In this case, all of the features described or shown form the subject matter of the present invention individually or in any combination, irrespective of their wording or representation in the description or in the figures.

### BRIEF DESCRIPTION OF THE DRAWINGS

FIG. 1 schematically shows a simplified flowchart according to exemplary embodiments of the present invention.

FIG. 2 schematically shows a simplified block diagram according to exemplary embodiments of the present invention.

FIG. 3 schematically shows a simplified flowchart according to exemplary embodiments of the present invention.

FIG. 4 schematically shows a simplified flowchart according to exemplary embodiments of the present invention.

FIG. 5 schematically shows a simplified flowchart according to exemplary embodiments of the present invention.

FIG. 6 schematically shows a simplified block diagram according to exemplary embodiments of the present invention.

FIG. 7 schematically shows a simplified block diagram according to exemplary embodiments of the present invention.

FIG. 8 schematically shows a simplified block diagram according to exemplary embodiments of the present invention.

FIG. 9 schematically shows a simplified block diagram according to exemplary embodiments of the present invention.

FIG. 10 schematically shows a simplified block diagram according to exemplary embodiments of the present invention.

FIG. 11 schematically shows a simplified block diagram according to exemplary embodiments of the present invention.

FIG. 12 schematically shows a simplified block diagram according to exemplary embodiments of the present invention.

FIG. 13 schematically shows a simplified block diagram according to exemplary embodiments of the present invention.

FIG. 14 schematically shows aspects of uses according to exemplary embodiments of the present invention.

### DETAILED DESCRIPTION OF EXAMPLE EMBODIMENTS

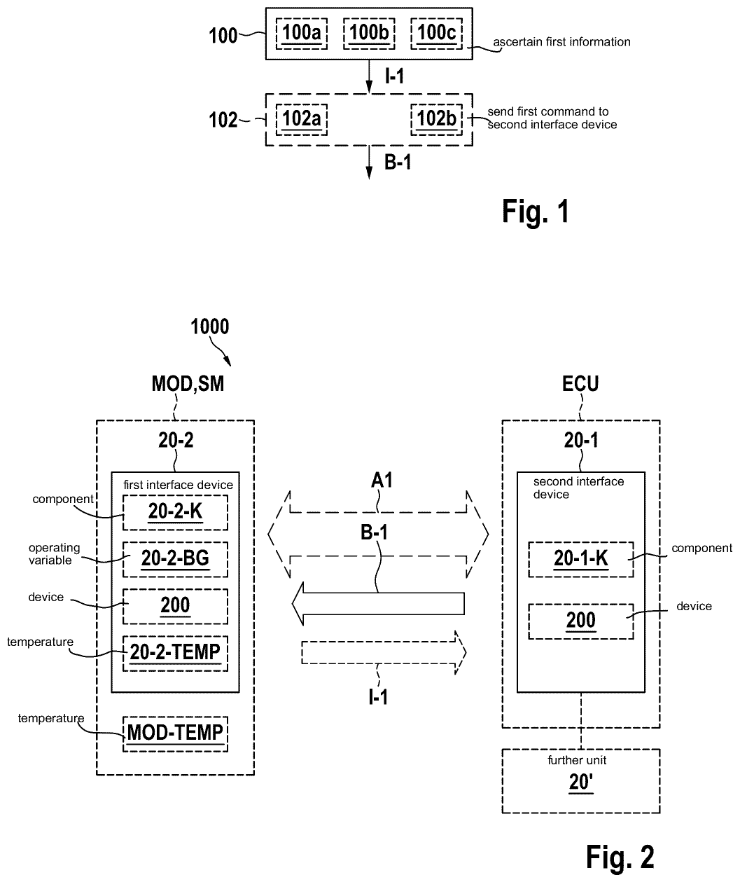

Exemplary embodiments, shown in FIG. 1, relate to a method, for example a computer-implemented method, for processing data associated with at least one interface device 20-1, 20-2 (FIG. 2), comprising: ascertaining 100 (FIG. 1) first information I-1 which indicates whether at least one component 20-2-K (FIG. 2) of a second interface device 20-2 designed to at least temporarily exchange data A1 with a first interface device 20-1 is to be set to an energy-saving mode, and, if the first information I-1 indicates that the at least one component 20-2-K of the second interface device 20-2 is to be set to the energy-saving mode, sending 102 (FIG. 1) a first command B-1 to the second interface device 20-2, said command signaling to the second interface device 20-2 that the at least one component 20-2-K of the second interface device 20-2 is to be set to the energy-saving mode. In further exemplary embodiments, an operation of the at least one component 20-2-K of the second interface device 20-2, for example with regard to an energy-saving mode, can thereby be flexibly controlled, for example by the first interface device 20-1 or a target system for the first interface device 20-1 (e.g., a control unit (not shown) comprising the first interface device 20-1).

In further exemplary embodiments, the first information can be represented, for example, by at least one bit, e.g., bit flag.

In further exemplary embodiments, it is provided that, for example on the basis of the first information I-1 and/or the first command B-1, at least one component 20-1-K of the first interface device 20-1 is, e.g., also, set to an energy-saving mode.

In further exemplary embodiments, it is provided that, if the first information I-1 indicates that the at least one component 20-2-K of the second interface device 20-2 is not, e.g., not at the moment, to be set to the energy-saving mode, sending 102 (FIG. 1) the first command B-1 to the second interface device 20-2 is not carried out, i.e., is omitted.

In further exemplary embodiments, the energy-saving mode is characterized in that an electrical power consumption and/or energy consumption (for example, averaged over a specifiable time interval) in the energy-saving mode (e.g., of the corresponding component 20-1-K, 20-2-K) is lower than outside the energy-saving mode, for example in a regular operating mode.

In further exemplary embodiments, FIG. 2, it may be provided that, even if its at least one component 20-2-K is in the energy-saving mode, the second interface device 20-2 can exchange data, e.g., with the first interface device 20-1, e.g., in the sense of the data exchange already described above by way of example. For example, a, e.g., maximum, data rate can be reduced in the energy-saving mode in comparison to the regular operating mode, which can result in savings in terms of electrical power consumption and/or energy consumption, for example. For example, the, for example maximum, data rate achievable in the energy-saving mode may be sufficient to exchange signals or information that can be used for synchronizing the second interface device with the first interface device.

In further exemplary embodiments, the energy-saving mode can be characterized, for example, in that the data rate in the energy-saving mode corresponds to the data rate of the regular operating mode, wherein it is however defined, for example, that, during the energy-saving mode, data transmissions (e. g., at the regular data rate) only take place in a specifiable first fraction (e.g., 10 percent) of a, or the, for example, specifiable time interval (“duty cycle”), while, for example, in a further fraction of the specifiable time interval, for example in the remaining time period of the specifiable time interval, (e.g., 90%) no data transmissions take place. This can also result in savings with regard to electrical power consumption and/or energy consumption, e.g., averaged over the specifiable time interval, in further exemplary embodiments.

In further exemplary embodiments, FIG. 2, the at least one component 20-2-K of the second interface device 20-2, which can, for example, be set to the energy-saving mode at least temporarily, can, for example, be an interface module, for example a PHY module, or a component of a PHY module, e.g., a sending device (“transmitter”) of the PHY module. For details, see below, e.g., with regard to FIG. 7. For example, the at least one component 20-2-K of the second interface device 20-2 can be activated for the aforementioned first fraction (e.g., 10% of the specifiable time interval) and deactivated for the aforementioned second fraction (e.g., 90% of the specifiable time interval) during the energy-saving mode.

In further exemplary embodiments, FIG. 1, it is provided that the first command B-1 of the second interface device 20-2 signals that the at least one component 20-2-K of the second interface device 20-2 is to be set to the energy-saving mode for a specifiable time period.

In further exemplary embodiments, FIG. 2, it is provided that the first interface device 20-1 and the second interface device 20-2 are each designed as an Ethernet interface device, for example an automotive Ethernet interface device, for example according to or on the basis of at least one of the following standards: a) IEEE 802.bp, b) IEEE 802.3ch, c) IEEE 802.3cy, d) IEEE 802.3cg.

In further exemplary embodiments, it is provided that a component 20-1-K, 20-2-K of the first and/or second interface device 20-1, 20-2 that can, for example, be set to the energy-saving mode on the basis of the first command B-1 is, for example, an interface module, for example a PHY module, or a component of a PHY module, e.g., a sending device and/or a receiving device.

In further exemplary embodiments, FIG. 1, it is provided that ascertaining 100 the first information I-1 comprises at least one of the following elements: a) forming 100a the first information I-1, for example in the first interface device 20-1 or in a target system (e.g., control unit ECU) comprising the first interface device, b) forming 100b the first information I-1 on the basis of at least one operating variable (e.g., temperature) 20-2-BG of the second interface device 20-2 or of a target system MOD, SM comprising the second interface device 20-2, wherein, for example, the operating variable 20-2-BG of the second interface device 20-2 can be received by the first interface device 20-1 via a communication medium (e.g., wired Ethernet data connection, e.g., twisted-pair data transmission cable) that can be used for the data exchange A1, c) receiving 100c the first information I-1 by means of the second interface device 20-2 (e.g., local formation of the first information I-1 in the second interface device 20-2 or the module MOD or sensor module SM is also possible in further exemplary embodiments) and/or by means of at least one further unit 20′ (e.g., another control unit), e.g., via a data connection (wired and/or wireless) other than the data connection that can be used for the data exchange A1, and/or via the data connection that can be used for the data exchange A1.

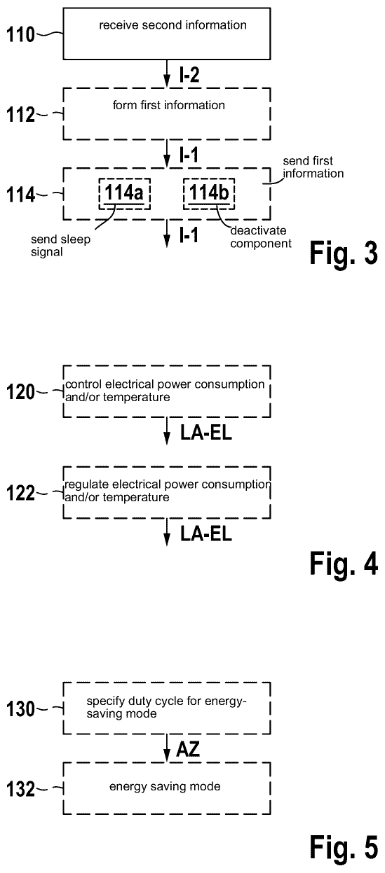

In further exemplary embodiments, FIG. 3, it is provided that the method comprises at least one of the following elements: a) receiving 110 second information I-2 (e.g., sensor data and/or operating variables, e.g., of another control unit or of a target system such as a vehicle) from at least one further unit 20′ (FIG. 2) (e.g., from a control unit or another control unit), b) forming 112 (FIG. 3) the first information I-1 on the basis of the second information I-2, c) sending 114 the first information I-1, e.g., to the second interface device 20-2, on the basis of the second information I-2, e.g., after receiving the second information I-2 or after forming the first information I-1 on the basis of the received second information I-2.

In further exemplary embodiments, FIG. 3, it is provided that sending 114 comprises: sending 114a a sleep signal to the second interface device 20-2 (FIG. 2) and, optionally, deactivating 114b (FIG. 3) at least one component 20-1-K (FIG. 2) of the first interface device 20-1 for a, or the, specifiable time period. As a result, the second interface device 20-2 can, for example, set its receiving device to the energy-saving mode, and the first interface device 20-1 can, for example, set its sender (not shown in FIG. 2; for details, see, e.g., FIG. 7), which is, for example, connected to the sending device of the second interface device 20-2 via a wired transmission medium, to the energy-saving mode.

In general, in further exemplary embodiments, at least one local component 20-1-K of a component (e.g., first interface device) 20-1 performing the method according to the embodiments can be set to an energy-saving mode at least temporarily, for example if the method provides for setting at least one component 20-2-K of the second interface device 20-2 to an energy-saving mode. This also applies to further exemplary embodiments, for example even if, for example, no EEE-compatible signals are used or can be used, for example, for signaling the first information I-1 and/or the first command B-1.

In further exemplary embodiments, FIG. 4, it is provided that the method comprises: controlling 120 and/or regulating 122 an electrical power consumption LA-EL of the second interface device 20-2 and/or a temperature 20-2-TEMP, MOD-TEMP (FIG. 2) of the second interface device 20-2 or of a target system, e. g., module MOD, e.g., sensor module SM, comprising the second interface device 20-2, for example by means of the first information I-1 or by sending 102 the first command B-1.

In further exemplary embodiments, FIG. 5, it is provided that the method comprises: specifying 130 a duty cycle AZ for the energy-saving mode of the at least one component 20-1-K, 20-2-K.

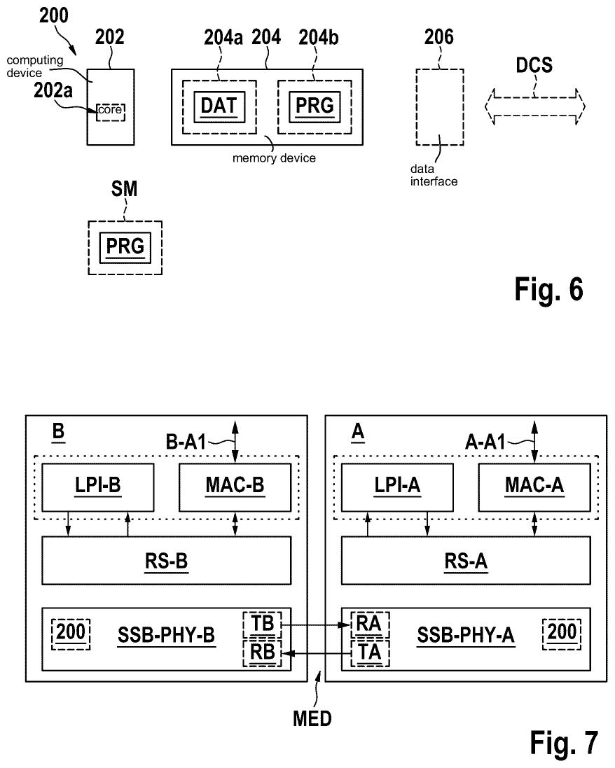

Further exemplary embodiments, FIG. 6, relate to a device 200 for performing the method according to the embodiments.

In further exemplary embodiments, it is provided that the device 200 comprises: a computing device (“computer”) 202 comprising at least one computing core 202a, a memory device 204, assigned to the computing device 202, for at least temporarily storing at least one of the following elements: a) data DAT (for example, the data characterizing the first and/or second information I-1, I-2), b) computer program PRG, for example for performing the method according to the embodiments.

In further exemplary embodiments, the memory device 204 has a volatile memory (for example, working memory (RAM)) 204a, and/or a non-volatile (NVM) memory (for example, flash EEPROM) 204b, or a combination thereof or with other types of memory not explicitly mentioned.

Further exemplary embodiments relate to a computer-readable storage medium SM comprising commands PRG that, when executed by a computer 202, cause said computer to perform the method according to the embodiments.

Further preferred embodiments relate to a computer program PRG comprising commands that, when the program PRG is executed by a computer 202, cause said computer to carry out the method according to the embodiments.

Further exemplary embodiments relate to a data carrier signal DCS that characterizes and/or transmits the computer program PRG according to the embodiments. The data carrier signal DCS can, for example, be received via an optional data interface 206 of the device 200, wherein the optional data interface 206 can, for example, be associated with the data exchange A1 (FIG. 2), e.g., can comprise the first interface device 20-1. Likewise, the first and/or second information I-1, 1-2 or data characterizing them can, for example, be transmitted (e.g., sent and/or received) via the optional data interface 206. In further exemplary embodiments, communication, e.g., data communication with the at least one further unit 20′ (FIG. 2) can also take place via the optional data interface 206.

Further exemplary embodiments, FIG. 7, relate to an interface module, for example PHY module SSB-PHY-B for an interface device B, comprising at least one device 200 or a functionality of the device 200 according to the embodiments. FIG. 7 shows, by way of example, a configuration for an Ethernet data connection with a first Ethernet interface device A and a second Ethernet interface device B.

In the schematic representation according to FIG. 7, it should be noted that the dashed blocks 200 are arranged purely symbolically within the PHY modules SSB-PHY-A, SSB-PHY-B, e.g., in order to express that, in some exemplary embodiments, the PHY modules SSB-PHY-A, SSB-PHY-B realize or implement at least some aspects of a functionality of the device 200. In further exemplary embodiments, at least some functional and/or structural aspects of the blocks 200 may also be arranged outside of the PHY modules SSB-PHY-A, SSB-PHY-B and, for example, may act at least temporarily on the PHY modules SSB-PHY-A, SSB-PHY-B (and/or on other components of the elements A, B).

The first Ethernet interface device A comprises the already mentioned PHY module, SSB-PHY-A, which may comprise aspects of the device 200 or may be designed to carry out at least some aspects of the method according to the embodiments. Furthermore, the first Ethernet interface device A comprises an optional reconciliation sublayer RS-A, which in the present case, for example, establishes a connection between the PHY module, SSB-PHY-A, a MAC (medium access control) device MAC-A and, optionally, an LPI client LPI-A. The double arrow A-A1 symbolizes an optional data connection of the MAC device MAC-A to a data source and/or data sink, not shown in FIG. 7 for reasons of clarity, e.g., comprising or associated with at least one of the following elements: a) microprocessor (e.g., of a control unit), b) microcontroller (e.g., of a control unit), c) sensor, d) network coupling element, e.g., switch.

The second Ethernet interface device B comprises, analogously to the first Ethernet interface device A, a PHY module SSB-PHY-B, which optionally may, for example, also comprise aspects of the device 200 or may be designed to carry out at least some aspects of the method according to the embodiments but does not necessarily have to comprise aspects 200 of the device 200 or is not necessarily designed to carry out at least some aspects of the method according to the embodiments. Furthermore, the second Ethernet interface device B comprises an optional reconciliation sublayer RS-B, which in the present case, for example, establishes a connection between the PHY module SSB-PHY-B, a MAC device MAC-B and, optionally, an LPI client LPI-B. The double arrow B-A1 symbolizes an optional data connection of the MAC device MAC-B to a data source and/or data sink, not shown in FIG. 7 for reasons of clarity, e.g., comprising or associated with at least one of the following elements: a) microprocessor (e. g., of a control unit), b) microcontroller (e.g., of a control unit), c) sensor, d) network coupling element, e.g., switch.

In further exemplary embodiments, at least one of the LPI clients LPI-A, LPI-B may, for example, also comprise aspects of the device 200 or may be designed to carry out at least some aspects of the method according to the embodiments.

In further exemplary embodiments, the LPI clients LPI-A, LPI-B can, for example, be integrated or implemented in the corresponding MAC device MAC-A, MAC-B, see also the dotted line that surrounds the elements MAC-A, LPI-A or MAC-B, LPI-B in each case.

In further exemplary embodiments, the LPI clients LPI-A, LPI-B can, for example, exchange signals of the type “LP_IDLE.indication,” e.g., in the sense of the first information I-1 (FIG. 1) or the first command B-1.

In further exemplary embodiments, the two PHY modules SSB-PHY-A, SSB-PHY-B are configured as master-slave tuples and translate incoming data from the MAC layer, e.g., the MAC devices MAC-A or MAC-B, into physical signals, e.g., modulated voltage levels (signals) on a transmission medium MED, and vice versa.

In further exemplary embodiments, full duplex operation is, for example, provided, e.g., at all times. This means in further exemplary embodiments that both PHY modules SSB-PHY-A, SSB-PHY-B send and/or receive at a maximum specified data rate, e.g., according to a standards-based definition: 10 Mbps (100 Mbps 100BASE-T, 1 Gbps 1GBASE-T1, 2.5/5/10 Gbps MGBASE-T1).

The PHY module SSB-PHY-A comprises a sending device (“transmitter”) TA and a receiving device (“receiver”) RA for this purpose. The PHY module SSB-PHY-B comprises a sending device (“transmitter”) TB and a receiving device (“receiver”) RB for this purpose. As can be seen in FIG. 7, the transmitter TA is connected to the receiver RB and the transmitter TB is connected to the receiver RA.

In further exemplary embodiments, the PHY modules SSB-PHY-A, SSB-PHY-B generate, for example if there are no data that come from the MAC layer and are to be transmitted via the medium MED, e.g., pseudorandom data that are transmitted by means of the transmitters TA, TB, resulting in a corresponding, e. g., maximum, electrical power consumption even through there are currently no data from the MAC layer that are to be sent or regardless of whether there are data from the MAC layer that are to be sent. In further exemplary embodiments, this analogously also applies to the receivers RA, RB, which implement, for example, hybrid (digital and analog) signal processing, e.g., comprising echo cancellation, adaptive equalizing (e.g., equalization), etc.

In further exemplary embodiments, aspects of the energy-efficient Ethernet (EEE) can be implemented, as they are, for example, standardized, e.g., for reducing electrical power consumption, e.g., in the absence of data from the MAC layer that are to be sent. For this purpose, in further exemplary embodiments, a logic can be implemented, for example by means of the LPI clients LPI-A, LPI-B. For example, the LPI clients LPI-A, LPI-B can send so-called idle requests (e.g., of the type “assert” or “deassert”) to the corresponding connection partner.

In further exemplary embodiments, the LPI client LPI-B shown on the left in FIG. 7 can, for example, send an LP_IDLE.indication(assert) command via the optional reconciliation sublayer RS-B and the PHY module SSB-PHY-B to the Ethernet interface device A, which thus knows that the connection or the link TB to RA (i.e., the data connection between the transmitter TB and the receiver RA) will enter an energy-saving mode, e.g., a low-power idle operation, e.g., for a specifiable period. During this period, the PHY module SSB-PHY-B can deactivate its transmitter TB and the connection partner SSB-PHY-A can deactivate its receiver RA, thus saving electrical energy. In further exemplary embodiments, the components TB, RA can be activated temporarily, e.g., for a short time each (see the duty cycle already mentioned above), e.g., in order to maintain synchronization of the two PHY modules SSB-PHY-A, SSB-PHY-B and/or to make possible transmission of information associated with the energy-saving mode or a termination of the energy-saving mode, e. g., of so-called “LP_IDLE.indication(deassert)” commands, in order to set the link TB, RA from the energy-saving mode back to a regular operating mode, in which, e.g., the two components TB, RA (e.g., in contrast to the energy-saving mode) are permanently activated and can transmit data at the maximum data rate, for example.

In further exemplary embodiments, the method described above by way of example with reference to the link TB, RA can, for example alternatively or additionally, also be applied to the link TA, RB.

In further exemplary embodiments, aspects, for example methods or protocols, e.g., of an EEE-related part of an Ethernet standard, can, for example, be used, e.g., in order to at least temporarily control an operation of the second interface device 20-2 (FIG. 2) (or of at least one of its components 20-2-K) on the basis of the first information I-1 and/or by means of the first command B-1.

In further exemplary embodiments, the principle according to the embodiments can, for example, be used to provide energy-efficient communication or communication systems 1000 (FIG. 2), e.g., for applications that carry out an information transfer from/to a module MOD (FIG. 2), for example sensor module SM. For example, the sensor module can comprise at least one of the following elements: camera, RADAR sensor, LIDAR sensor, actuator(s) (e.g., projector light of an LED or LASER emitter, which modulates light waves, for example, in the sense of a sender, in order to use the light waves to transmit information to a remote receiver (e.g., on the basis of visible light communication (VLC), optical wireless communication (OWC), display, etc.). For example, data sources and/or sinks for applying the principle according to the embodiments, can comprise at least one of the following elements, e.g., in addition to the modules mentioned above by way of example, e.g., sensor modules: control unit, e.g., ECU, vehicle computer, sensor hub, zonal control unit (zonal ECU), etc.

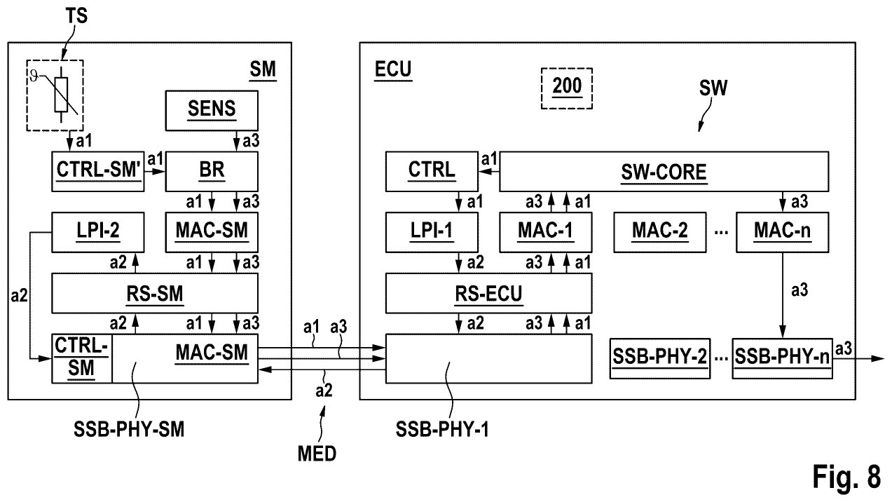

FIG. 8 schematically shows a simplified block diagram according to exemplary embodiments, in which aspects according to exemplary embodiments can be used to carry out regulation, e.g., closed-loop-control, of an operating variable, e.g., temperature, of a sensor module SM. For example, the temperature regulation can serve to regulate an electrical power dissipated by the sensor module SM or at least one component thereof, for example in order to comply with thermal boundary conditions, e.g., those specified by a design or layout, for proper operation of the sensor module SM.

A control unit ECU comprises a first PHY module SSB-PHY-1, which is designed at least temporarily to carry out at least some aspects of the principle according to the embodiments. This is symbolized in FIG. 8, by way of example, by the indication of the device 200 in the area of the control unit ECU. In some embodiments, for example, the device 200 may be at least partially integrated into the control unit ECU. However, in some further embodiments, at least part of a functionality of the device 200 may, for example, also be integrated into at least one other component of the control unit ECU, for example in the first PHY module SSB-PHY-1, i.e., the device 200 is not integrated as such, e.g., structurally, into the control unit ECU.

The elements SSB-PHY-2, . . . , SSB-PHY-n symbolize further PHY modules, which may be provided in the control unit ECU in further exemplary embodiments. The elements MAC-1, MAC-2, . . . , MAC-n symbolize, for example, MAC devices of the control unit ECU that are assigned to the corresponding PHY modules, according to further exemplary embodiments. The element SW-CORE symbolizes a switch core associated with the MAC devices MAC-1, MAC-2, . . . , MAC-n and, e.g., comprising a coupling network. The element LPI-1 symbolizes an optional LPI client. The element CTRL symbolizes an optional control device designed, for example, to carry out aspects of the method according to the embodiments. The element RS-ECU symbolizes an optional reconciliation sublayer.

The element SSB-PHY-SM symbolizes a PHY module of the sensor module SM, wherein a control device CTRL-SM may optionally be assigned to the PHY module SSB-PHY-SM. The element RS-SM symbolizes an optional reconciliation sublayer of the sensor module SM. The element MAC-SM symbolizes a MAC device of the sensor module SM. The element LPI-2 symbolizes an optional LPI client of the sensor module SM. The element BR symbolizes an optional bridge device of the sensor module SM. The element CTRL-SM′ symbolizes an optional further control device of the sensor module SM, to which, for example, a temperature sensor TS is connected. The element SENS symbolizes a sensor unit of the sensor module SM, e.g., a digital image sensor and/or a RADAR device and/or a LIDAR device or the like.

In further exemplary embodiments, the components SSB-PHY-SM, LPI-2 of the sensor module SM operate in an EEE-compatible or EEE-compliant manner so that, for example, the control unit ECU can send the first command B-1 (see also FIG. 1) to the sensor module SM via the communication connection MED, for example in order to request the sensor module SM to switch at least one of its components (e.g., a receiver (not shown in FIG. 8; see, for example, element RB according to FIG. 7)) to an energy-saving mode. For this purpose, in some embodiments, it may be sufficient if the sensor module SM operates in an EEE-compliant manner, but it is not necessary, for example, for the sensor module SM to carry out aspects according to exemplary embodiments, because these aspects are carried out, by way of example, in the sphere of the control unit ECU.

In further exemplary embodiments, the control unit ECU can receive information, characterizing temperature measurement values of the temperature sensor, (cf., for example, the second information I-2 described above by way of example) via the communication connection MED and, on this basis, can, for example, ascertain whether at least one component of the sensor module SM is to be set to an energy-saving mode, for example if the temperature measurement values indicate that a specifiable maximum temperature is exceeded.

In further exemplary embodiments, a functional chain for transmitting information, characterizing the temperature measurement values, from the temperature sensor TS of the sensor module SM to the control device CTRL of the control unit ECU according to the arrows al is possible, for example. If, for example, a specifiable maximum temperature is exceeded, the control device CTRL can act on the LPI client LPI-1, e.g., in order to cause the sensor module SM to enter an energy-saving mode (e.g., at least for one component of the sensor module SM). In further exemplary embodiments, a functional chain for this purpose is, for example, possible from the control device CTRL of the control unit ECU to the control device CTRL-SM of the PHY module SSB-PHY-SM according to the arrows a2.

In further exemplary embodiments, the control device CTRL can, for example, configure the LPI client LPI-1 such that it sets the duty cycle in terms of energy-saving modes of the PHY module SSB-PHY-SM of the sensor module SM such that the electrical power consumption of the PHY module SSB-PHY-SM is reduced, for example until the thermal boundary conditions for the sensor module SM are fulfilled, e.g., again, for example until a specifiable maximum temperature of the sensor module SM is not met.

In further exemplary embodiments, the principle described above by way of example can also be applied to the PHY module SSB-PHY-1 of the control unit ECU, for example regardless of the configuration described above and, e.g., the data flow direction, wherein, in this case, at least partial aspects of the exemplary embodiments can, for example, be implemented in the control device CTRL-SM, for example.

In further exemplary embodiments, the arrows a3 in FIG. 8 symbolize possible paths for sensor data, such as may be provided by the sensor unit SENS of the sensor module SM.

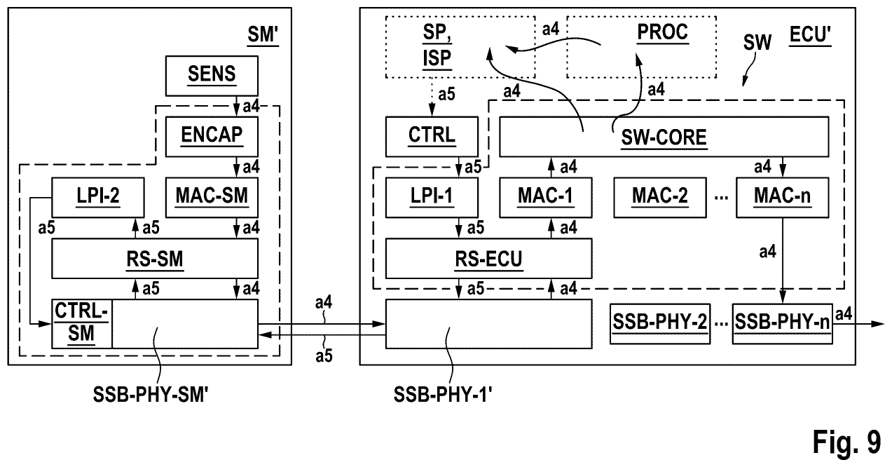

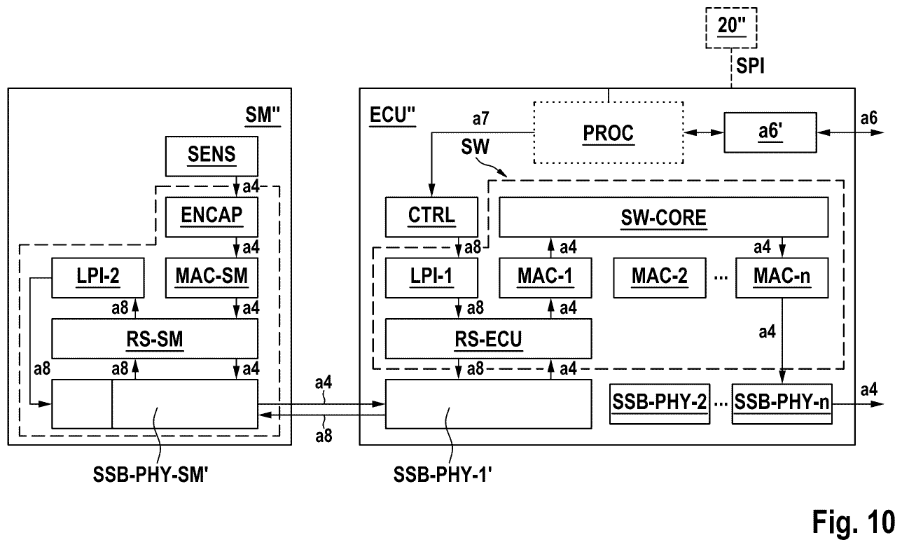

FIG. 9 schematically shows a simplified block diagram according to further exemplary embodiments. Similarly to FIG. 8, a control unit ECU′ and a sensor module SM′ are shown, which predominantly comprise similar or identical components as the control unit ECU and the sensor module SM according to FIG. 8.

In further exemplary embodiments, for example if temperature information is not available in the area of the sensor module, as is, for example, the case with the sensor module SM′ according to FIG. 9, an energy-saving mode or a duty cycle for an energy-saving mode can be initiated or controlled or regulated, for example on the basis of the sensor data of the sensor device SENS of the sensor module SM′ or on the basis of data that can be derived therefrom.

For example, in the sensor module SM′ according to FIG. 9, the sensor device SENS can be designed as a camera, for example having a digital image sensor. In further exemplary embodiments, an effective data rate of the camera SENS can be regulated, e.g., throttled to a specifiable level, for example by activating an energy-saving mode of, for example, at least one component of the PHY module SSB-PHY-SM′ comparatively often, for example via the LPI client LPI-1 of the control unit ECU′, for example on the basis of data that a signal processor SP, for example image data signal processor ISP of the control unit ECU′, ascertains on the basis of sensor data received from the sensor module SM′ (cf. the arrows a4). Optionally, the received sensor data can be processed, for example by the processor PROC of the control unit ECU′ and/or by the image data signal processor ISP. On this basis, the LPI client LPI-1 can then, for example, be controlled, cf. the arrows a5, for example in order to activate an energy-saving mode of, for example, at least one component of the PHY module SSB-PHY-SM′. In further exemplary embodiments, the throttling of the effective data rate on the basis of the, e.g., repeated, activation of energy-saving modes of, for example, at least one component of the PHY module SSB-PHY-SM′ can, for example, take place if an evaluation of the sensor data shows that, for example, an image content characterized by the sensor data does not change or does not change significantly (in a manner exceeding a specifiable threshold value). If a, e.g., significant, change in the image content is detected, the energy-saving mode can, for example, be deactivated, for example likewise by means of the LPI client LPI-1.

FIG. 10 schematically shows a simplified block diagram according to further exemplary embodiments. Similarly to FIG. 9, a control unit ECU″ and a sensor module SM″ are shown, which predominantly comprise similar or identical components as the control unit ECU′ and the sensor module SM′ according to FIG. 9. Similarly to FIG. 9, the arrows a4 in FIG. 10 symbolize a data flow of sensor data received from the sensor module SM″, via the switch core SW-CORE of the control unit ECU″ to the PHY module SSB-PHY-n. In other words, in the exemplary configuration according to FIG. 10, the sensor data of the sensor module SM″ that are received by the control unit ECU″ are forwarded via the PHY module SSB-PHY-n, for example to another unit not shown (e.g., central network element of a communication network that also comprises the elements ECU″, SM″). The arrow a6 symbolizes a data connection of the control unit ECU″ to a further unit (likewise not shown), e.g., via a CAN bus; the element a6′ symbolizes a CAN transceiver which is, for example, directly connected to the processor PROC, and the arrow a7 symbolizes a control of the control device CTRL, for example on the basis of the data which the control unit ECU″ or the processor PROC has received via the CAN bus a6. The control a7 can, for example, act on the LPI client LPI-1, for example in order to set at least one component of the sensor module SM″ to an energy-saving mode at least temporarily, see the arrows a8 according to FIG. 10, for example on the basis of the data that the control unit ECU″ or the processor PROC has received via the CAN bus a6.

In further exemplary embodiments, the configuration described above by way of example with reference to FIG. 10 can be used for the processor PROC of the control unit ECU″ to control and/or regulate an electrical power consumption and/or energy consumption of the PHY module SSB-PHY-SM′ (and thus, for example, at least indirectly also the temperature of the PHY module SSB-PHY-SM′ or of the sensor module SM″) (“cross-protocol information”), for example on the basis of a RADAR detection signaled via the CAN bus (e.g., by a RADAR sensor device not shown).

In further exemplary embodiments, other information, for example associated with a periphery of the control unit ECU″ (“peripheral information”), can also be used, for example in order to ascertain whether at least one component of a communication partner SM″ of the control unit ECU″ and/or at least one component of the control unit ECU″ itself is to be set to an energy-saving mode at least temporarily, and/or in order to ascertain, for example, a corresponding duty cycle for the energy-saving mode. For example, information, e.g., sensor information, of one or more other units 20″, for example devices or sensor modules, etc., which are not themselves connected to the control unit ECU″ by means of Ethernet, e.g., automotive Ethernet, can thus, for example, also be used to control the energy-saving mode for at least one component, e. g., of the sensor module SM″ and/or of the control unit ECU″, for example in the sense of the first information I-1 or the first command B-1 (see FIG. 1).

For example, the element 20″ according to FIG. 10 can symbolize a sensor that is connected to the control unit ECU″ via a serial interface SPI. The sensor 20″ supplies sensor data (not shown) to the control unit ECU″ via the serial interface SPI, e.g., in the sense of the second information I-2 described above by way of example with reference to FIG. 3, and the control unit ECU″ controls an energy-saving mode or duty cycle for the energy-saving mode for at least one component, e.g., of the sensor module SM′ and/or of the control unit ECU′ on the basis of the sensor data received from the sensor 20′ via the SPI interface. In further exemplary embodiments, the PHY modules SSB-PHY-SM′, SSB-PHY-1′ . . . of the sensor module SM″ and of the control unit ECU″ can, for example, be set to the energy-saving mode on the basis of the sensor data received from the sensor 20″ via the SPI interface, for example for a comparatively long time, and can be reactivated, e.g., in an event-based manner, for example if the sensor data received from the sensor 20″ via the SPI interface characterize a corresponding event, upon the occurrence of which the PHY modules SSB-PHY-SM′, SSB-PHY-1′, . . . of the sensor module SM″ and of the control unit ECU″ are to leave the energy-saving mode. A, for example comparatively less complex, SPI-based sensor device can thus, for example, control an energy-saving mode of the PHY modules SSB-PHY-SM′, SSB-PHY-1′, . . . of the sensor module SM″ and of the control unit ECU″ or influence a corresponding control.

Further exemplary embodiments, FIG. 9, 10, relate to a network coupling element, for example switch SW, for example automotive switch SW, comprising at least one device 200 according to the embodiments (or a functionality corresponding to the device 200) and/or at least one interface module SSB-PYH-1, SSB-PHY-1′ according to the embodiments. In further exemplary embodiments, at least some aspects of the functionality corresponding to the device 200 can be realized or implemented in at least one of the following components of the control unit ECU″ according to FIG. 10: SSB-PHY-1′, LPI-1, CTRL, PROC (or, in further exemplary embodiments, in any combination thereof).

Further exemplary embodiments, cf., for example, FIG. 8, 9, 10, relate to a module, for example sensor module SM, SM′, SM″ and/or control unit ECU, ECU′, ECU″, comprising at least one device according to the embodiments (or a functionality corresponding to the device 200) and/or at least one interface module according to the embodiments and/or at least one network coupling element SW according to the embodiments.

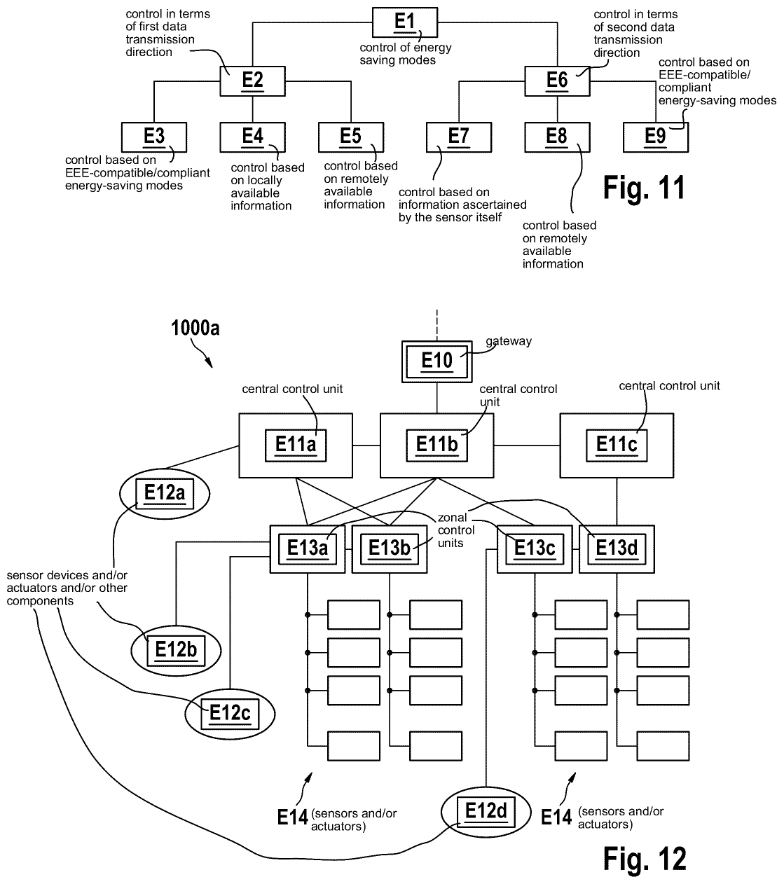

FIG. 11 schematically shows a simplified block diagram according to exemplary embodiments. The blocks E1 to E9 symbolize exemplary aspects or variants of the principle according to the embodiments, as can be provided in further exemplary embodiments. In detail, the blocks symbolize the following:
E1: a control of energy-saving modes of at least one component 20-1-K, 20-2-K of at least one interface device 20-1, 20-2, for example using aspects of EEE (energy-efficient Ethernet), for example on the basis of information that can, for example, come from different spheres (e.g., from sensor modules SM, SM′, SM″ connected via Ethernet, e.g., automotive Ethernet, from a control unit ECU, ECU′, ECU″ performing the method, from a further unit, for example sensor device 20″, which is also connected to a control unit ECU, ECU′, ECU″ performing the method, in a manner other than by means of Ethernet, e. g., automotive Ethernet, for example via CAN or another bus system, or via SPI, LIN, FlexRay, I²C, etc.),
E2: a control according to block E1 in terms of a first data transmission direction, for example sending direction, for example in relation to a particular interface device, for example controllable by means of a local LPI client,
E3: a control according to block E2, on the basis of, e.g., EEE-compatible or EEE-compliant, energy-saving modes, e.g., in the receiving direction,
E4: a control according to block E2, on the basis of locally available information, e.g., data of a temperature sensor, image data of a camera device,
E5: a control according to block E2, on the basis of remotely available information, e.g., data, e.g., from sensors, which can, for example, be exchanged, e.g., received, via a network or an interface,
E6: a control according to block E1 in terms of a second data transmission direction, for example receiving direction, for example in relation to a particular interface device, for example controllable by means of a remotely arranged LPI client (i.e., for example, by means of an LPI client of a communication partner),
E7: a control according to block E6, on the basis of information that can, for example, be ascertained by a sensor itself (e.g., data of a temperature sensor, image data of a camera device),
E8: a control according to block E6, on the basis of remotely available information, e.g., data, e.g., from sensors, which can, for example, be exchanged, e.g., received, via a network or an interface,
E9: a control according to block E6, on the basis of, e.g., EEE-compatible or EEE-compliant, energy-saving modes, e.g., in the sending direction.

FIG. 12 schematically shows a simplified block diagram of a communication system 1000a according to exemplary embodiments. Element E10 symbolizes, by way of example, a gateway. The elements E11a, E11b, E11c symbolize, by way of example, central control units (e.g., “central ECU(s)”). The elements E12a, E12b, E12c, E12d symbolize, by way of example, sensor devices and/or actuators or other components that are associated with a high data rate, which thus, for example, at least temporarily send and/or receive data at a high data rate. The elements E13a, E13b, E13c, E13d symbolize, by way of example, control units, e.g., zonal control units (e.g., “zonal ECU(s)”). The elements collectively denoted by reference signs E14 symbolize sensors and/or actuators.

The principle according to the embodiments can be used advantageously in one or more components of the communication system 1000a, for example in the area of the elements E11a, E11b, E11c, E12a, . . . , E12d, which ensures energy-efficient and at the same time performant data communication in further exemplary embodiments.

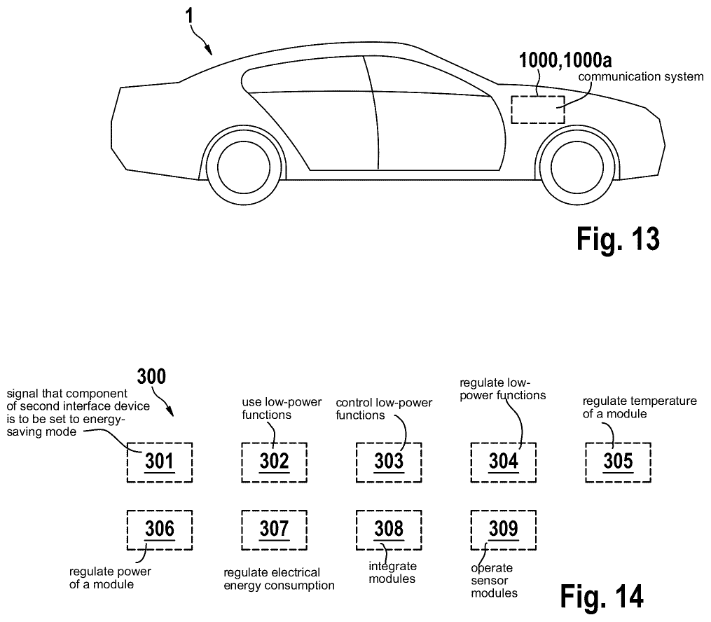

Further exemplary embodiments, FIG. 1, 13, relate to a communication system 1000, 1000a, for example for a vehicle 1 (FIG. 13), comprising at least one device 200 according to the embodiments (or a functionality corresponding to the device 200) and/or at least one interface module according to the embodiments and/or at least one network coupling element SW according to the embodiments and/or at least one module SM, SM′, SM″, ECU, ECU′, ECU″ according to the embodiments.

Further exemplary embodiments, FIG. 1, 13, relate to a vehicle 1 having at least one communication system 1000, 1000a according to the embodiments.

Further exemplary embodiments, FIG. 14, relate to a use 300 of the method according to the embodiments and/or of the device 200 according to the embodiments and/or of the interface module according to the embodiments and/or of the network coupling element SW according to the embodiments and/or of the module SM, SM′, SM″, ECU, ECU′, ECU″ according to the embodiments and/or of the communication system 1000, 1000a according to the embodiments and/or of the computer-readable storage medium SM according to the embodiments and/or of the computer program PRG according to the embodiments and/or of the data carrier signal DCS according to the embodiments for at least one of the following elements: a) signaling 301 that the at least one component 20-2-K of the second interface device 20-2 is to be set to the energy-saving mode, b) using 302 low-power functions, for example an energy-saving mode, of the at least one component of the second interface device, c) controlling 303 and/or regulating 304 low-power functions, for example an energy-saving mode, of the at least one component of the second interface device, d) regulating 305 the temperature of a module MOD, for example a sensor module SM, for example a camera module, comprising the second interface device 20-2, e) regulating 306 the power of a module MOD, for example a sensor module SM, for example a camera module, comprising the second interface device 20-2, f) regulating 307 an electrical energy consumption of a module comprising the second interface device 20-2, g) integrating 308 modules MOD, for example sensor modules SM, for example sensor modules designed to output data at a comparatively high data rate, for example of greater than 1000Mbit/s, into a communication system 1000, 1000a, for example an automotive Ethernet communication system, h) operating 309 sensor modules, for example of the RADAR type and/or LIDAR type and/or camera type.

1-17. (canceled).

18. A computer-implemented method for processing data associated with at least one interface device, comprising the following steps:
ascertaining first information which indicates whether at least one component of a second interface device configured to at least temporarily exchange data with a first interface device is to be set to an energy-saving mode; and
based on the first information indicating that the at least one component of the second interface device is to be set to the energy-saving mode, sending a first command to the second interface device, the first command signaling to the second interface device that the at least one component of the second interface device is to be set to the energy-saving mode.

19. The method according to claim 18, wherein the first command sent to the second interface device signals that the at least one component of the second interface device is to be set to the energy-saving mode for a specifiable time period.

20. The method according to claim 18, wherein the first interface device and the second interface device are each an Ethernet interface device according to at least one of the following standards: a) IEEE 802.bp, b) IEEE 802.3ch, c) IEEE 802.3cy, d) IEEE 802.3cg.

21. The method according to claim 18, wherein the ascertaining of the first information includes at least one of the following elements: a) forming the first in the first interface device or in a target system including the first interface device, b) forming the first information based on at least one operating variable of the second interface device or of a target system including the second interface device, wherein the operating variable of the second interface device can be received by the first interface device via a communication medium that can be used for the data exchange, c) receiving the first information using the second interface device and/or at least one further unit.

22. The method according to claim 18, further comprising at least one of the following elements: a) receiving second information from at least one further unit, b) forming the first information based on the second information, c) sending the first information based on the second information.

23. The method according to claim 18, wherein the sending includes: sending a sleep signal to the second interface device, and deactivating at least one component of the first interface device for a specifiable time period.

24. The method according to claim 18, further comprising:
controlling and/or regulating: (i) an electrical power consumption of the second interface device, and/or (ii) a temperature of the second interface device or of a target system including the second interface device.

25. The method according to claim 18, further comprising:
specifying a duty cycle for the energy-saving mode of the at least one component.

26. A device configured to process data associated with at least one interface device, the device configured to:
ascertain first information which indicates whether at least one component of a second interface device configured to at least temporarily exchange data with a first interface device is to be set to an energy-saving mode; and
based on the first information indicating that the at least one component of the second interface device is to be set to the energy-saving mode, send a first command to the second interface device, the first command signaling to the second interface device that the at least one component of the second interface device is to be set to the energy-saving mode.

27. The device according to claim 26, wherein the device is comprised in an interface module for an interface device.

28. The device according to claim 26, wherein the device is comprised in an automotive switch.

29. The device according to claim 26, wherein the device is comprised in a sensor module and/or a control unit.

30. The device according to claim 26, wherein the device is comprised in a communication system for a vehicle.

31. A non-transitory computer-readable storage medium on which are stored commands for processing data associated with at least one interface device, the commands, when executed by a computer, causing the computer to perform the following steps:
ascertaining first information which indicates whether at least one component of a second interface device configured to at least temporarily exchange data with a first interface device is to be set to an energy-saving mode; and
based on the first information indicating that the at least one component of the second interface device is to be set to the energy-saving mode, sending a first command to the second interface device, the first command signaling to the second interface device that the at least one component of the second interface device is to be set to the energy-saving mode.

32. The method according to claim 18, wherein the method is used for at least one of the following elements: a) signaling that the at least one component of the second interface device is to be set to the energy-saving mode, b) using low-power functions of the at least one component of the second interface device, c) controlling and/or regulating low-power functions of the at least one component of the second interface device, d) regulating a temperature of a sensor module including the second interface device, e) regulating power of a sensor module, including the second interface device, f) regulating an electrical energy consumption of a module including the second interface device, g) integrating sensor modules configured to output data at a data rate greater than 1000 Mbit/s, into an automotive Ethernet communication system, h) operating RADAR or LIDAR sensor modules.
